(19) United States
(12) Patent Application Publication
(10) Pub. No.: US 2007/0097448 A1
(43) Pub. Date: May 3, 2007

(54) PRINT SYSTEM AND ACCESS CONTROL METHOD THEREOF, ACCESS CONTROL PROGRAM, INFORMATION PROCESSING DEVICE, AND STORAGE MEDIUM

(75) Inventor: Hiroko Iizuka, Tokyo (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/555,406

(22) Filed: Nov. 1, 2006

(30) Foreign Application Priority Data
Nov. 2, 2005 (JP) 2005-319988
Oct. 23, 2006 (JP) 2006-287979

(51) Int. Cl. G06K 15/00

(52) U.S. Cl. 358/403; 358/1.16

(57) ABSTRACT

A print system, which comprises a print data issuance device which issues print data, a printing device which executes printing based on the print data output from the print data issuance device, and an access control device which generates access control information required to limit user's access to the printing device, reduces labor of setting and management of access control information by making integrated management of access control information, and facilitates installation of a driver for the printing device.

### BACKGROUND OF THE INVENTION

1. Field of the Invention

The present invention relates to a print system having a function of limiting user accesses and an access control method thereof, and a control program for implementing the access control method.

2. Description of the Related Art

Of recent printer devices, a printer device of a type that can limit device operations based on access control information set for a login user upon login to the printer device is known (see Japanese Patent Laid-Open No. 2000-163240).

Japanese Patent Laid-Open No. 2000-163240 discloses a technique for limiting command inputs to allow only a user who has authentic usage rights to use the printer device in accordance with a user authentication table and access control table. The access control table holds, as access control information, security levels for respective service IDs, and a list of users who are permitted to receive services.

However, Japanese Patent Laid-Open No. 2000-163240, because printer access control information is maintained on the printer side, each printer must maintain user access information and integrated access control information management is not possible. Because of this, a problem arises in that maintenance and management of access control information requires much labor.

### SUMMARY OF THE INVENTION

The present invention has as its one feature to provide a print system and an access control method thereof, which reduce labor of setting and management of access control information by making integrated management of the access control information, and can facilitate installation of a driver for a printing device, and an access control program.

According to the present invention, the foregoing object is attained by providing a print system which has a print data issuance device which issues print data, a printing device which executes printing based on the print data output from the print data issuance device, and an access control device which generates access control information required to limit user's access to the printing device,

the access control device comprising:

a storage unit adapted to integrally store list information associated with access limitations for respective users to the printing device;

an access control information generation unit adapted to generate the access control information based on the list information stored in the storage unit; and

a user notification information generation unit adapted to generate user notification information associated with the access limitations to the printing device based on the access control information generated by the access control information generation unit, and

the printing device comprising:

an information acquisition unit adapted to acquire the access control information and the notification information from the access control device;

a notification unit adapted to notify the user of the user notification information; and

an issuance unit adapted to issue print data based on the access control information.

According to the present invention, the foregoing object is attained by providing an access control method for a print system which comprises a print data issuance device which issues print data, a printing device which executes printing based on the print data output from the print data issuance device, and an access control device which generates access control information required to limit user's access to the printing device,

a method to be executed by the access control device, comprising:

a storage step of integrally storing list information associated with access limitations for respective users to the printing device in a storage unit;

an access control information generation step of generating the access control information based on the list information stored in the storage unit; and

a user notification information generation step of generating user notification information associated with the access limitations to the printing device based on the access control information generated in the access control information generation step, and

a method to be executed by the printing device, comprising:

an information acquisition step of acquiring the access control information and the notification information from the access control device;

a notification step of notifying the user of the user notification information; and

an issuance step of issuing print data based on the access control information.

According to the present invention, the foregoing object is attained by providing an computer-readable access control program for implementing an access control method for a print system which comprises a print data issuance device which issues print data, a printing device which executes printing based on the print data output from the print data issuance device, an access control device which generates access control information required to limit user's access to the printing device, and a storage unit which integrally stores list information associated with access limitations for respective users to the printing device,

a program installed in the access control device, comprising:

an access control information generation step of generating the access control information based on the list information stored in the storage unit; and

a user notification information generation step of generating user notification information associated with the access limitations to the printing device based on the access control information generated in the access control information generation step, and

a program installed in the printing device, comprising:

an information acquisition step of acquiring the access control information and the notification information from the access control device;

a notification step of notifying the user of the user notification information; and

an issuance step of issuing print data based on the access control information.

According to the present invention, the foregoing object is attained by providing an information processing device comprising:

a setting unit adapted to set access control information that limits user's access to a printing device;

a change unit adapted to change the access control information set by the setting unit;

an acquisition unit adapted to acquire a print attribute of print data to be issued by a user;

a generation unit adapted to generate user notification information indicating that processing of print data using the print attribute of a job acquired by the acquisition unit cannot be permitted to the user, using the access control information changed by the change unit; and

a transmission unit adapted to transmit the user notification information generated by the generation unit to an external information processing device.

According to the present invention, the foregoing object is attained by providing an access control method comprising:

a setting step of setting access control information that limits user's access to a printing device;

a change step of changing the access control information set in the setting step;

an acquisition step of acquiring a print attribute of print data to be issued by a user;

a generation step of generating user notification information indicating that processing of print data using the print attribute of a job acquired in the acquisition step cannot be permitted to the user, using the access control information changed in the change step; and

a transmission step of transmitting the user notification information generated in the generation step to an external information processing device.

Further features of the present invention will become apparent from the following description of exemplary embodiments with reference to the attached drawings.

### BRIEF DESCRIPTION OF THE DRAWINGS

FIG. 1 is a block diagram showing the network configuration of a print system according to an embodiment of the present invention;

FIG. 2 is a block diagram showing the basic internal arrangement of each device in FIG. 1;

FIG. 3 is a block diagram showing program modules equipped in respective devices according to the embodiment of the present invention;

FIG. 4 is a table showing an example of an ACL (access control list) stored in a database;

FIG. 5 is a flowchart showing the operation of a client PC;

FIGS. 6A and 6B are flowcharts showing the operation on the server device side according to the embodiment of the present invention;

FIG. 7 shows an example of a popup dialog of user notification UI information;

FIG. 8 shows an example of a management table on an access control database, to which a new limitation item is added;

FIG. 9 shows an example of warning messages after the new limitation item is added; and

FIG. 10 shows an example of warning messages after the new limitation item is added.

### DESCRIPTION OF THE EMBODIMENTS

### First Embodiment

The first embodiment of the present invention will be described hereinafter with reference to the accompanying drawings.

<Network Configuration>

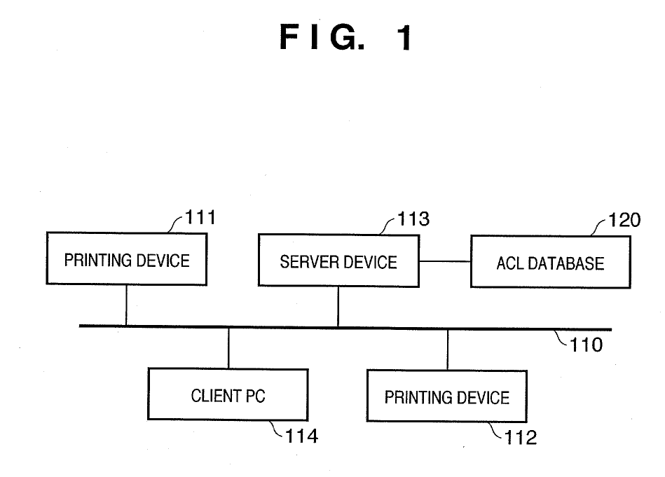

FIG. 1 is a block diagram showing the network configuration of a print system according to the embodiment of the present invention.

The print system according to this embodiment comprises a printing device 111 and 112, a server device 113 to which a database 120 is connected, and a client PC 114. These devices are connected to each other via a network 110.

The database 120 stores an ACL (Access Control List) as list information which pertains to access limitations for respective users who use the printing device 111 or 112. The server device 113 issues a print right. That is, the server device 113 has a function of generating access control information of each user based on the ACL information. The client PC 114 is a computer which issues a print request, and generates print data according to the access control information. The printing devices 111 and 112 actually print images according to print data from the client PC 114.

<Internal Arrangement of Each Device>

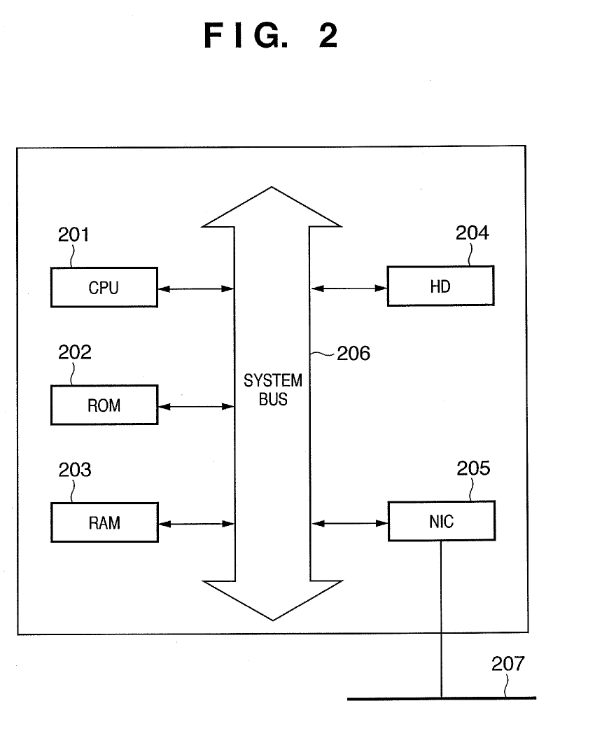

FIG. 2 is a block diagram showing the basic internal arrangement of each device shown in FIG. 1.

The server device 113 and client PC 114 shown in FIG. 1 have basically the same arrangement. Each of the printing devices 111 and 112 has an arrangement equivalent to that shown in FIG. 2, to which a printer main body (not shown) is further connected to a system bus 206 via a device controller (not shown).

More specifically, in each of these devices, a CPU 201, ROM 202, RAM 203, hard disk (HD) 204, and network interface card (NIC) 205 are connected to each other via a system bus 206.

The CPU 201 executes software stored in the ROM 202 or a large-capacity storage device such as a hard disk 204 or the like, and systematically controls devices connected to the system bus 206.

The RAM 203 serves as a main memory, work area, and the like of the CPU 201. The NIC 205 exchanges data with other network devices in two ways via a LAN 207. The database 120 is assured on the hard disk 204 or RAM 203 on the server device 113.

Note that the client PC 114 comprises a display device such as a liquid crystal display or the like, and input devices such as a keyboard, pointing device, and the like, in addition to the above devices.

<Program Modules Equipped in Respective Devices>

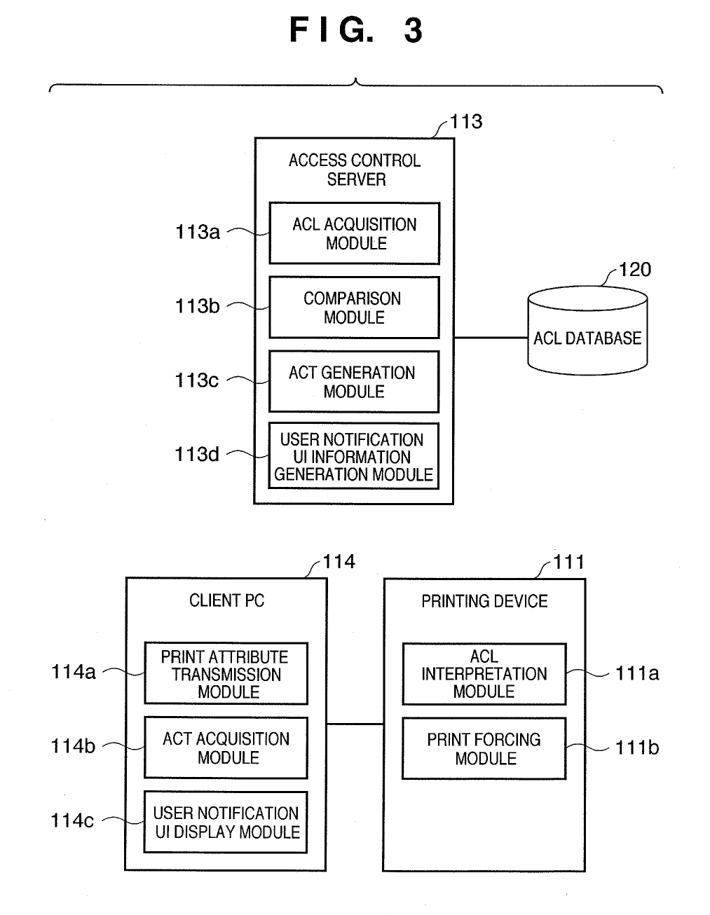

Program modules equipped in the server device 113, client PC 114, and printing devices 111 and 112 will be described below using FIG. 3.

FIG. 3 is a block diagram showing program modules equipped in the respective devices according to this embodiment.

The server device 113 comprises program modules: an ACL acquisition module 113a, comparison module 113b, ACT generation module 113c, and user notification UI information generation module 113d. The ACL acquisition module 113a acquires an ACL of the user from the database 120 in response to an ACL acquisition request from the client PC 114. The comparison module 113b compares a print attribute received from the client PC 14 with the ACL acquired by the ACL acquisition unit 113a. The ACT generation module 113c generates access control information (ACT: Access Control Token) based on the ACL acquired by the ACL acquisition unit 113a. The user notification UI information generation module 113d generates user notification UI information (to be described later) based on the comparison result of the comparison module 113b.

The client 114 comprises a driver which has program modules: a print attribute transmission module 114a, ACT acquisition module 114b, and user notification UI display module 114c. The print attribute transmission module 114a transmits print attribute information of data to be printed (print data) to the server device 113. The ACT acquisition module 14b requests the server device 113 to transmit the ACT and acquires it. The user notification UI display module 114c displays user notification UI information received from the server device 113 on the display device.

Each of the printing devices 111 and 112 comprises program modules: an ACL interpretation module 111a that interprets the ACL of print data issued by the client PC 114, and a print forcing module 111b which acquires the interpretation result and forces a print output.

<Access Control List (ACL) Database>

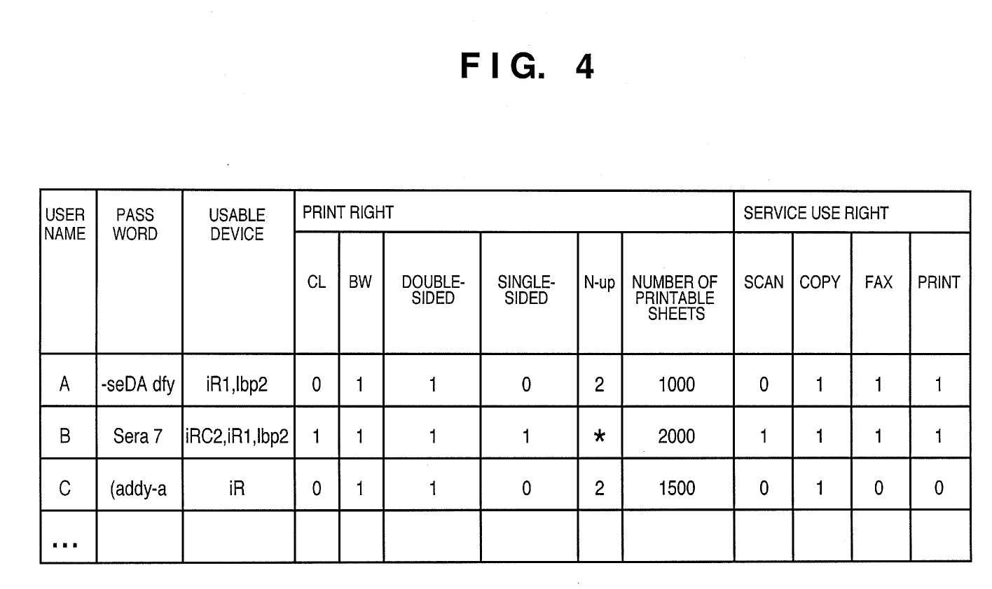

FIG. 4 is a table showing an example of the ACL (access control list) stored in the database 120.

As shown in FIG. 4, in this ACL (access control list), security attributes such as a password, usable device, print right, and service use right are set for each user name.

The “usable device” column registers a list of device names that can be used by respective users. The “print right” column stores values indicating permission/inhibition of print attributes (e.g., color, monochrome, double-sided printing, single-sided printing, N-UP printing, etc.) for respective users. The “service use right” column stores values indicating permission/inhibition of services (e.g., scan, copy, FAX, print, etc.) for respective users.

An example will be described below using FIG. 4. The user of user name “A” can use devices “iR1” and “lbp2”, and the print right of that user includes only “color printing inhibited”, “monochrome printing permitted”, “double-sided printing permitted”, “single-side printing inhibited”, and “2-UP printing permitted”. Furthermore, the service use right of that user is set with information associated with access limitations such as “scan service inhibited”, copy service permitted”, “FAX service permitted”, and “print service permitted”.

### Print Processing According to This Embodiment

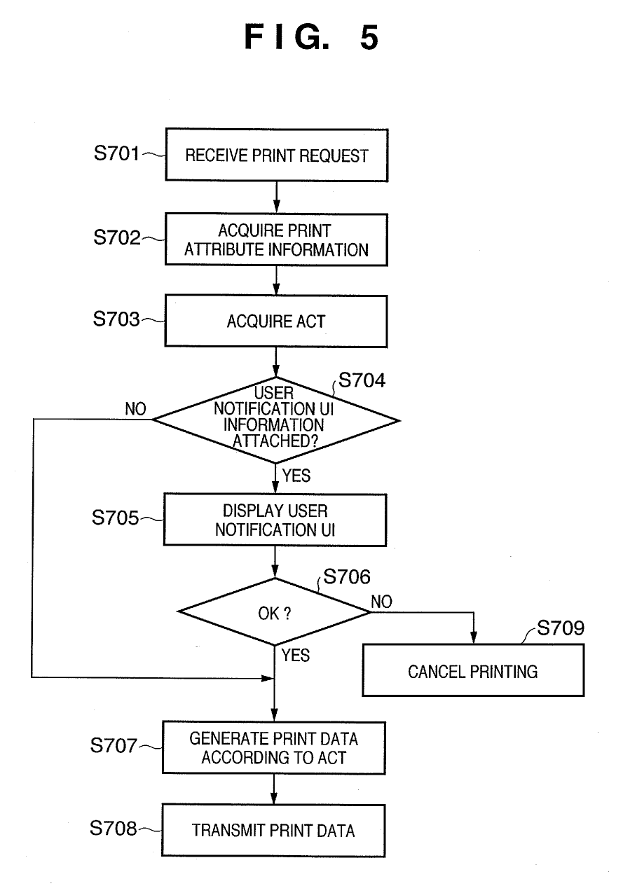

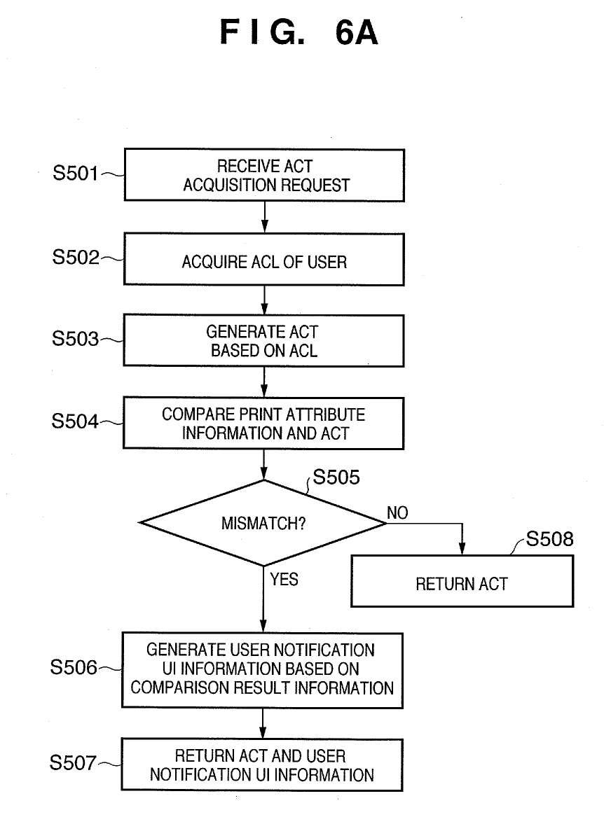

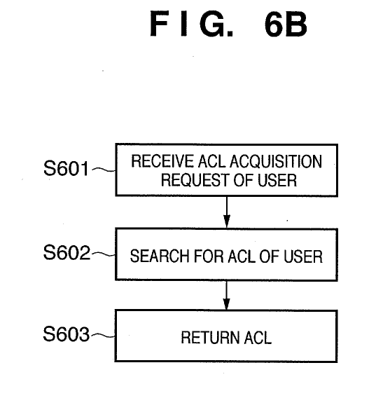

The operations of the client PC 114 and server device 113 which execute the print processing according to this embodiment will be described below with reference to FIG. 5 and FIGS. 6A and 6B.

FIG. 5 is a flowchart showing the operation of the client PC 114. The CPU 201 on the client PC 114 executes this operation. FIGS. 6A and 6B are flowcharts showing the operation on the server device 113 side. FIG. 6A shows the main operation of the server device 113, and FIG. 6B shows the partial detailed operation of the main operation (details of step S502: operation associated with the database 120). The CPU 201 on the server device 113 executes this operation.

Referring to FIG. 5, when the CPU 201 on the client PC 114 receives a print request of, e.g., user A from an application, a program starts (step 701). In step 702, the CPU 201 acquires print attribute information for the print request of user A. In step 703, the CPU 201 transmits an ACT acquisition request attached with the acquired print attribute information to the server device 113, and receives an ACT from the server device 113.

The operation on the server device 113 side at that time will be described below with reference to FIGS. 6A and 6B.

Referring to FIG. 6A, when the CPU 201 on the server device 113 receives the ACT acquisition request from the client PC 114, a program starts. In step 501, upon reception of the ACT acquisition request by the server device 113, the CPU 201 extracts the user name of user A who issued the print request and print attribute information of print data with reference to data in packets of the ACT acquisition request.

In step 502, the ACL acquisition module 113a of the server device 113 acquires an ACL of user A from the database 120. In step 503, the ACL acquisition module 113a generates an ACT of user A based on the ACL. In step 504, the comparison module 113b compares the print attribute information of the print data with the contents of the ACT. If they do not match (step 505), the process advances to step 506. For example, when the driver of the client PC 114 selects color printing in a print attribute setting, but the ACT sets color printing=“0” (inhibited), if the ACT and print attribute information are compared, it is revealed that they do not match, i.e., the ACT and print setting have inconsistency.

In step 506, the user notification UI information generation module 113d generates user notification UI information based on the comparison result information between the ACT and print attribute obtained in step 505. That is, the module 113d combines inconsistencies between the contents of the print attribute information and ACT, and generates user notification UI information described in, e.g., HTML or XML. After that, in step 507 the CPU 201 returns the ACT generated in step 503 and the user notification UI information to the client PC 114.

If it is determined in step 505 that the result in step 504 indicates a match, the process advances to step 508. In step 508, the CPU 201 returns the ACT generated in step 503 to the client PC 114.

The operation of the ACL database 120 corresponding to the processing in step 502 will be described below using the flowchart of FIG. 6B. The CPU 201 on the server device 113 executes this operation.

Upon reception of the ACL acquisition request of user A by the server device 113 in step 502 in FIG. 6A, a program starts (step 601), and the process advances to step 602. In step 602, the CPU 201 searches the database 120 based on user name “A” to acquire the ACL of user A, and the process advances to step 603. In step 603, the CPU 201 returns the acquired ACL to the main operation in FIG. 6A, thus ending the operation in step 502.

Referring back to FIG. 5, the operation of the client PC 114 in step 704 and subsequent steps will be described.

In step 703, the CPU 201 acquires the ACT of user A by the aforementioned operation on the server device 113 side. After that, the CPU 201 checks in step 704 if the user notification UI information is attached to the ACT acquired in step 703. If the user notification UI information is attached, the process advances to step 705; otherwise, the process jumps to step 707.

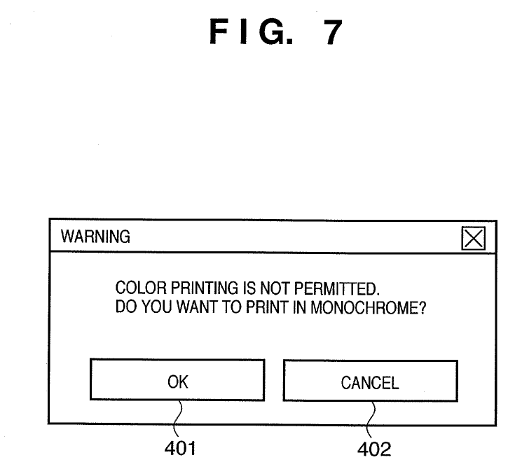

In step 705, the CPU 201 displays the user notification UI information using a popup dialog or the like. FIG. 7 shows an example of this popup dialog. The popup dialog in this example of FIG. 7 is displayed when the print attribute information acquired in step 702 in response to the print request of user A includes “color printing”, and the contents of the ACL of user A acquired by the server device 113 include “color printing inhibited” and “monochrome printing permitted”. The display device of the client PC 114 displays the popup dialog with the contents “Color printing is not permitted. Do you want to print in monochrome?”, as shown in FIG. 7.

Note that the user notification UI information is described in HTML or XML, and the client PC 114 calls an application such as a browser or the like held by itself, which can interpret HTML or XML, and displays the user notification UI information.

The CPU 201 then checks in step 706 if the user has pressed an “OK” button 401 on the user notification UI information displayed on the popup dialog. If the user has pressed the “OK” button 401, the process advances to step 707.

In step 707, the client PC 114 generates print data according to the contents of the ACT by automatically modifying the print attribute for the print request of user A from “color printing” to “monochrome printing”. In step 708, the CPU 201 transmits the print data to the printing device 111 or 112. If the user has pressed a “cancel” button 402 on the user notification UI information in step 706, the CPU 201 cancels the print processing.

### Advantages of this Embodiment

According to this embodiment, the database 120 which stores a list of access control information for respective users in an integrated fashion is provided. The server device 113 generates access control information (ACT) of the user who issued a print request based on the list information (ACL) in this database 120. The server device 113 compares the print attribute of the print request and the access control information. If they include inconsistent items, the server device 113 appends user notification UI information to the access control information, and sends that access control information to the client PC 114. The client PC 114 displays the user notification UI information and can notify the user that the print setting contents include errors.

In this way, since the driver of the client PC 114 need only be installed to request the server device 113 to send access control information independently of the printer device (e.g., the printing device 111 or 112) to be used, driver installation becomes easy.

Furthermore, since the server device 113 side generates the user notification UI information based on the comparison result information between the ACT and print attribute, the driver side need only have a logic for receiving (message) data to be displayed on a user interface. Even upon adding a new security attribute, such new security attribute can be coped with without changing installation on the driver side.

The server device 113 can make integrated management of access control information which was conventionally managed for each printer device, thus reducing labor of the setting and management of access control information for each user.

### Second Embodiment

The second embodiment of the present invention will be described hereinafter with reference to the accompanying drawings. “Capability of generation and display of a user notification UI corresponding to a new limitation item without changing any installation on the client side when the new limitation item is added” as the effect of the present invention will be described below using the accompanying drawings.

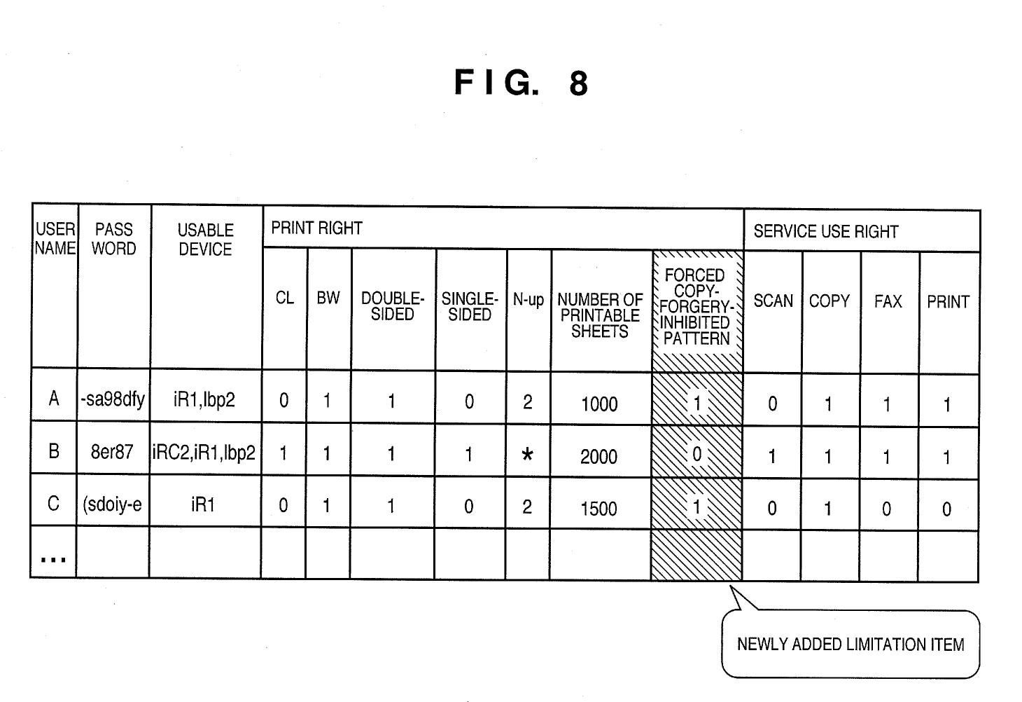

FIG. 8 shows an example of a management table on the access control database after a new limitation item is added. In this example, a limitation item “forced copy-forgery-inhibited pattern printing” is added as an example of a new limitation item.

When the new limitation item is added, the administrator sets authorities of users on the management table. FIG. 8 shows an example in which forced copy-forgery-inhibited pattern printing is ON for user A, it is OFF for user B, and it is ON for user C.

The operation executed when user A sets “color printing” and “no copy-forgery-inhibited pattern printing” from an application and inputs a print request in the printer driver will be described below with reference to the flowcharts and other drawings.

When the CPU 201 on the client PC 114 receives the print request of user A from the application, the program shown in the flowchart of FIG. 5 starts (step 701).

In step 702, the CPU 201 acquires print attribute information (color printing designation and no copy-forgery-inhibited pattern designation information in this case) for the print request of user A. That is, the CPU 201 acquires print attribute information from data in print request packets by the application. In step 703, the CPU 201 transmits an ACT acquisition request attached with the acquired print attribute information to the server device 113, and receives an ACT from the server device 113.

The operation on the server device 113 side at that time will be described below with reference to FIGS. 6A and 6B.

Referring to FIG. 6A, when the CPU 201 on the server device 113 receives the ACT acquisition request from the client PC 114, the program starts. In step 501, upon reception of the ACT acquisition request by the server device 113, the CPU 201 extracts the user name of user A who issued the print request and print attribute information of print data with reference to data in packets of the ACT acquisition request.

In step 502, the ACL acquisition module 113a of the server device 113 acquires an ACL (more specifically, “color printing inhibited”, “single-sided printing inhibited”, “2-up forced”, “the number of printable sheets=1000”, and “forced copy-forgery-inhibited pattern printing=ON”) of user A from the database 120. Furthermore, in step 503 the ACL acquisition module 113a generates an ACT of user A based on the ACL. In step 504, the comparison module 113b compares the print attribute information of the print data with the contents of the ACT. If they do not match (step 505), the process advances to step 506. In this case, since the driver of the client PC 114 selects “color printing” and “no copy-forgery-inhibited pattern printing” in the print attribute settings, but “color printing=“0” (inhibited)”, and “forced copy-forgery-inhibited pattern printing=“1” (ON)” are set in the ACT, if the ACT and print attribute information are compared, it is revealed that they do not match, i.e., the ACT and print setting have inconsistency.

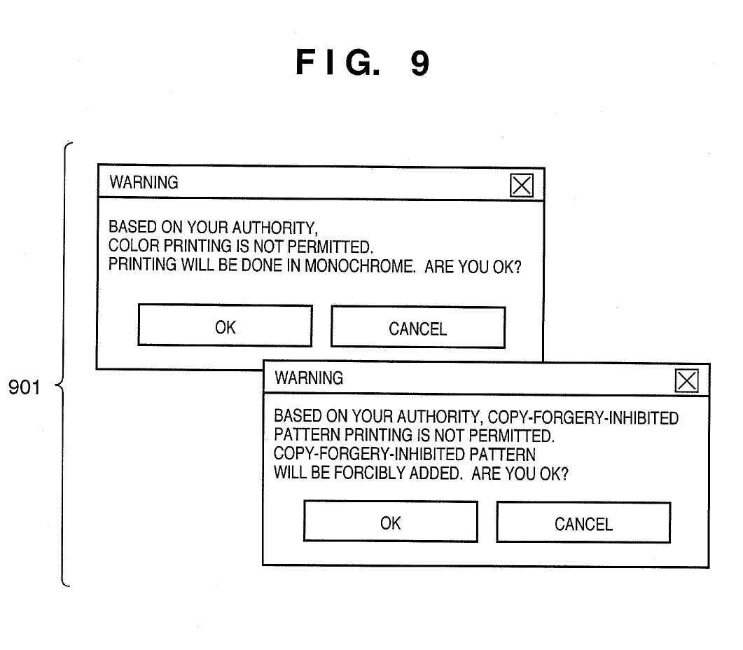

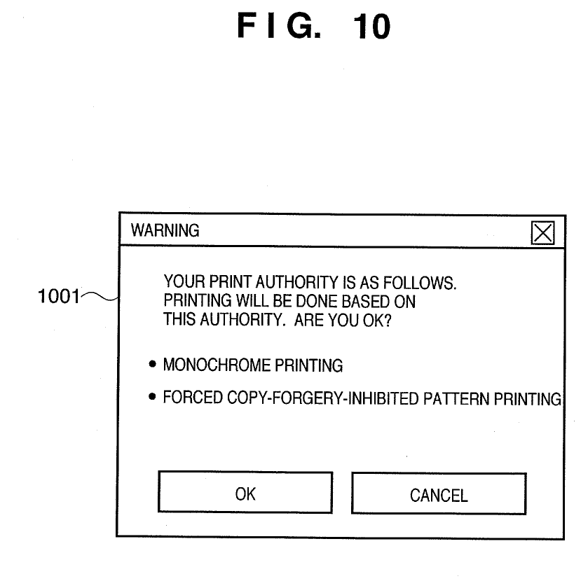

In step 506, the user notification UI information generation module 113d generates user notification UI information based on the comparison result information between the ACT and print attribute obtained in step 505. That is, the module 113d combines inconsistencies between the contents of the print attribute information and ACT, and generates user notification UI information described in, e.g., HTML or XML. In this case, FIGS. 9 and 10 show examples of the user notification UIs. After that, in step 507 the CPU 201 returns the ACT generated in step 503 and the user notification UI information to the client PC 114.

The operation of the ACL database 120 corresponding to the processing in step 502 will be described below using the flowchart of FIG. 6B. The CPU 201 on the server device 113 executes this operation.

Upon reception of the ACL acquisition request of user A by the server device 113 in step 502 in FIG. 6A, the program starts (step 601), and the process advances to step 602. In step 602, the CPU 201 searches the database 120 based on user name “A” to acquire the ACL of user A, and the process advances to step 603. In step 603, the CPU 201 returns the acquired ACL to the main operation in FIG. 6A, thus ending the operation in step 502.

Referring back to FIG. 5, the operation of the client PC 114 in step 704 and subsequent steps will be described.

In step 703, the CPU 201 acquires the ACT of user A by the aforementioned operation on the server device 113 side. After that, the CPU 201 checks in step 704 if the user notification UI information is attached to the ACT acquired in step 703. If the user notification UI information is attached, the process advances to step 705; otherwise, the process jumps to step 707.

In step 705, the CPU 201 displays the user notification UI information using a popup dialog or the like. FIGS. 9 and 10 show examples of popup dialogs 901 and 1001, respectively. These popup dialogs in the examples of FIGS. 9 and 10 are displayed when the print attribute information acquired in step 702 in response to the print request of user includes “color printing” and “no copy-forgery-inhibited pattern printing”, and the contents of the ACL of user A acquired by the server device 113 include “color printing inhibited”, “single-sided printing inhibited”, and “forced copy-forgery-inhibited pattern printing=ON”. The display device of the client PC 114 displays warning messages after the new limitation item is added on the popup dialogs, as shown in FIGS. 9 and 10.

According to this embodiment, even when a new print attribute that can be limited is added, a user notification UI which is also intended for the newly added attribute can be generated without changing the program on the client side and can be displayed on the client PC, thus notifying the user that printing cannot be done according to the user's print designation.

Note that the objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention.

As the storage medium for supplying the program code, for example, a floppy® disk, hard disk, magneto-optical disk, optical disks such as a CD-ROM, CD-R, CD-RW, DVD-ROM, DVD-RAM, DVD-RW, DVD+RW, and the like, magnetic tape, nonvolatile memory card, ROM, and the like may be used. Also, program codes may be downloaded via a network.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-319988, filed Nov. 2, 2005, and Japanese Patent Application No. 2006-287979, filed Oct. 23, 2006, which are hereby incorporated by reference herein in their entirety.

What is claimed is:

1. A print system which has a print data issuance device which issues print data, a printing device which executes printing based on the print data output from said print data issuance device, and an access control device which generates access control information required to limit user's access to said printing device,
said access control device comprising:
a storage unit adapted to integrally store list information associated with access limitations for respective users to said printing device;
an access control information generation unit adapted to generate the access control information based on the list information stored in said storage unit; and
a user notification information generation unit adapted to generate user notification information associated with the access limitations to said printing device based on the access control information generated by said access control information generation unit, and
said printing device comprising:
an information acquisition unit adapted to acquire the access control information and the notification information from said access control device;
a notification unit adapted to notify the user of the user notification information; and
an issuance unit adapted to issue print data based on the access control information.

2. The system according to claim 1, wherein said access control device further comprising:
an attribute information acquisition unit adapted to acquire print attribute information of the print data from said print data issuance device, and
said user notification information generation unit compares the print attribute information acquired by said attribute information acquisition unit and the access control information generated by said access control information generation unit, and generates the user notification information in accordance with the comparison result.

3. An access control method for a print system which comprises a print data issuance device which issues print data, a printing device which executes printing based on the print data output from the print data issuance device, and an access control device which generates access control information required to limit user's access to the printing device,
a method to be executed by the access control device, comprising:
a storage step of integrally storing list information associated with access limitations for respective users to the printing device in a storage unit;
an access control information generation step of generating the access control information based on the list information stored in the storage unit; and
a user notification information generation step of generating user notification information associated with the access limitations to the printing device based on the access control information generated in the access control information generation step, and
a method to be executed by the printing device, comprising:
an information acquisition step of acquiring the access control information and the notification information from the access control device;
a notification step of notifying the user of the user notification information; and
an issuance step of issuing print data based on the access control information.

4. An computer-readable access control program for implementing an access control method for a print system which comprises a print data issuance device which issues print data, a printing device which executes printing based on the print data output from the print data issuance device, an access control device which generates access control information required to limit user's access to the printing device, and a storage unit which integrally stores list information associated with access limitations for respective users to the printing device,
a program installed in the access control device, comprising:
an access control information generation step of generating the access control information based on the list information stored in the storage unit; and
a user notification information generation step of generating user notification information associated with the access limitations to the printing device based on the access control information generated in the access control information generation step, and
a program installed in the printing device, comprising:
an information acquisition step of acquiring the access control information and the notification information from the access control device;
a notification step of notifying the user of the user notification information; and
an issuance step of issuing print data based on the access control information.

5. An information processing device comprising:
a setting unit adapted to set access control information that limits user's access to a printing device;
a change unit adapted to change the access control information set by said setting unit;
an acquisition unit adapted to acquire a print attribute of print data to be issued by a user;
a generation unit adapted to generate user notification information indicating that processing of print data using the print attribute of a job acquired by said acquisition unit cannot be permitted to the user, using the access control information changed by said change unit; and
a transmission unit adapted to transmit the user notification information generated by said generation unit to an external information processing device.

6. The device according to claim 5, wherein said transmission unit transmits to the external information processing device user notification information generated before change processing by said change unit and user notification information generated after the change processing by said change unit.

7. An access control method comprising:
a setting step of setting access control information that limits user's access to a printing device;
a change step of changing the access control information set in the setting step;
an acquisition step of acquiring a print attribute of print data to be issued by a user;
a generation step of generating user notification information indicating that processing of print data using the print attribute of a job acquired in the acquisition step cannot be permitted to the user, using the access control information changed in the change step; and
a transmission step of transmitting the user notification information generated in the generation step to an external information processing device.

8. The method according to claim 7, wherein the transmission step includes a step of transmitting user notification information generated before change processing in the change step and user notification information generated after the change processing in the change step to the external information processing device.

9. A computer-readable storage medium for making a computer execute an access control method, said access control method comprising:
a setting step of setting access control information that limits user's access to a printing device;
a change step of changing the access control information set in the setting step;
an acquisition step of acquiring a print attribute of print data to be issued by a user;
a generation step of generating user notification information indicating that processing of print data using the print attribute of a job acquired in the acquisition step cannot be permitted to the user, using the access control information changed in the change step; and
a transmission step of transmitting the user notification information generated in the generation step to an external information processing device.
